(19) United States
(12) Patent Application Publication
(10) Pub. No.: US 2026/0298376 A1
(43) Pub. Date: Oct. 1, 2026

(54) COEXTRUDED TUBING AND METHODS OF MANUFACTURING THE SAME

(71) Applicant: Terumo BCT, Inc., Lakewood, CO (US)

(72) Inventors: Tanner LADTKOW, Arvada, CO (US); Steve SCHICK, Baraboo, WI (US); Sayudh GHOSH, Lakewood, CO (US)

(21) Appl. No.: 19/629,518

(22) Filed: Mar. 26, 2026

Related U.S. Application Data
(60) Provisional application No. 63/779,443, filed on Mar. 28, 2025.

(51) Int. Cl. F16L 11/20; B29C 48/00; B29C 48/21; B29K 75/00; B29L 9/00; B29L 23/00; F16L 11/04

(52) U.S. Cl. CPC F16L 11/20; B29C 48/022; B29C 48/21; F16L 11/04; B29K 2075/00; B29L 2009/00; B29L 2023/22

(57) ABSTRACT

A coextruded tubing includes a first layer having a first thickness and a second layer having a second thickness. The first layer includes a thermoplastic elastomer (TPE) and the second layer includes a thermoplastic polyurethane (TPU).

### CROSS-REFERENCE TO RELATED APPLICATION

This application claims the benefit of U.S. Provisional Application No. 63/779,443 filed on Mar. 28, 2025. The entire disclosure of the above application is incorporated herein by reference.

### TECHNICAL FIELD

The present disclosure relates to coextruded tubing and methods of manufacturing the same.

### BACKGROUND

Existing tubing in the medical industry is typically constructed from polyvinyl chloride (PVC). However, PVC may release various chemicals, such as plasticizer, during one or more heat cycles during manufacturing of the PVC and during incineration for disposal of the PVC. Because of the release of chemicals during the manufacturing process, PVC's performance and mechanical properties such as flexural modulus, elongation to yield, and compression set may be impacted. Further, the release of chemicals may impact chemical resistance, weather aspects such as UV impact, performance with adhesives, and/or methods of curing which may introduce environmental challenges related to PVC. For all of the above reasons, materials other than PVC may be desirable alternatives for use in the medical industry.

### SUMMARY

At least one example embodiment relates to a coextruded tubing. The coextruded tubing may include a first material having a first thickness and a second material having a second thickness. The first material may include thermoplastic elastomer (TPE) and the second material may include a thermoplastic polyurethane (TPU).

In at least one example embodiment, the second material may be configured to surround the first material.

In at least one example embodiment, the first material may be configured to surround the second material.

In at least one example embodiment, the first thickness may be greater than the second thickness.

In at least one example embodiment, the coextruded tubing may further include a bond material. In at least one example embodiment, the bond material may include polyolefin.

In at least one example embodiment, the second material may include the TPU blended with the TPE.

Also described herein is a method of manufacturing tubing. The method may include obtaining a first material and a second material and coextruding the first material with the second material to form the tubing. The first material may include a thermoplastic elastomer (TPE) and the second material may include a thermoplastic polyurethane (TPU).

In at least one example embodiment, the second material may be configured to surround the first material in the tubing

In at least one example embodiment, the first material may be configured to surround the second material in the tubing

In at least one example embodiment, the first material may be configured to have a first thickness that is greater than a second thickness of the second material.

Also described herein is a coextruded tubing that may include a first tube having a first thickness and a second tube having a second thickness. The first tube may include thermoplastic elastomer (TPE) and the second tube may include a thermoplastic polyurethane (TPU).

In at least one example embodiment, the second tube may be configured to surround the first tube.

In at least one example embodiment, the first tube may be configured to surround the second tube.

In at least one example embodiment, the first thickness may be greater than the second thickness.
at least one example embodiment, the coextruded tubing may further include a bond layer. In at least one example embodiment, the bond layer may include polyolefin.

In at least one example embodiment, the second tube may include the TPU blended with the TPE.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1A is cross-sectional view of tubing in accordance with at least one example embodiment.

FIG. 1B is a cross-sectional view of the tubing of FIG. 1A including a bond layer in accordance with at least one example embodiment.

FIG. 2A is a cross-sectional view of a second tubing in accordance with at least one example embodiment.

FIG. 2B is a cross-sectional view of the tubing of FIG. 2A including a bond layer in accordance with at least one example embodiment.

FIG. 3 is a flow chart of a method of manufacturing tubing in accordance with at least one example embodiment.

FIG. 4A is a perspective view of a film in accordance with at least one example embodiment.

FIG. 4B is a perspective view of the film of FIG. 4A including a bond layer in accordance with at least one example embodiment.

FIG. 5 is a flow chart of a method of manufacturing a film in accordance with at least one example embodiment.

FIG. 6 is a graph illustrating a change pump flow rate over time for tubing formed from various materials.

### DETAILED DESCRIPTION OF EXAMPLE EMBODIMENTS

Some detailed example embodiments are disclosed herein. However, specific structural and functional details disclosed herein are merely representative for purposes of describing some example embodiments. Example embodiments may, however, be embodied in many alternate forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit an example embodiment to the particular forms disclosed, but to the contrary, example embodiments are to cover all modifications, combinations, equivalents, and alternatives falling within the scope of an example embodiment. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiment.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiment only and is not intended to be limiting of example embodiment. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

Example embodiments are described herein with reference to cross-sectional illustrations that are schematic illustrations of example embodiment. As such, variations from the shapes of the illustrations are to be expected. Thus, example embodiment should not be construed as limited to the shapes of regions illustrated herein but are to include deviations and variations in shapes.

When the words “about” and “substantially” are used in this specification in connection with a numerical value, it is intended that the associated numerical value include a tolerance of ±10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiment belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

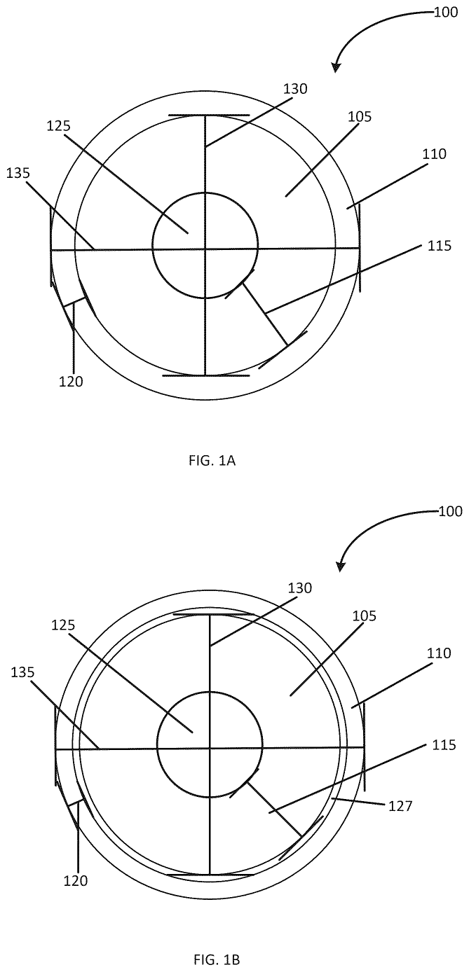

FIGS. 1A and 1B are cross-sectional views of tubing 100 according to at least one example embodiment. The tubing 100 may include a first material 105 and a second material 110. The first material 105 may be a first tube and the second material 110 may be a second tube in at least one example embodiment. As shown in FIG. 1A, the second tube may be an outer tube and the first tube may be an inner tube. The outer tube may surround an entirety of an outer circumference of the inner tube to form a circumferentially layered structure.

In at least one example embodiment, the first material 105 may be coextruded with the second material 110. The first material 105 may include or consist essentially of a thermoplastic elastomer (TPE) and the second material 110 may include or consist essentially of a thermoplastic polyurethane (TPU) in at least one example embodiment. As shown in FIG. 1A, the first material 105 may be located proximate to an interior of the tubing such that the first material 105 forms a conduit 125 of the tubing 100. The second material 110 may be coextruded with the first material 105 such that the second material 110 is located on an exterior of the tubing 100. For example, in at least one example embodiment, the first material 105 may be bonded directly to the second material 110. Bonding between the first material 105 and the second material 110 may be achieved through thermal, chemical, and/or mechanical methods. The thermal, chemical, and/or mechanical bonding methods may be concurrent, consecutive, or successive in at least one example embodiment. The bonding may be determined based on a layer structure of the materials and/or specific product design needs in at least one example embodiment.

In at least one example embodiment, the first material 105 may be a blend of TPU and TPE. Additionally, or alternatively, the second material 110 may be a blend of TPU and TPE. The blend of TPU and TPE for both the first material 105 and the second material 110 may be configured based on a desired cost and application of the tubing 100. In at least one example embodiment, the blend of TPU and TPE may be approximately 50% TPU and 50% TPE. However, example embodiments are not limited herein. In at least one example embodiment, the blend of TPU and TPE may be created by either blending the two polymers during a polymerization process or by first creating two polymers, mixing the two polymers, and then extruding the mixed polymers to create at least one of the first material 105 or the second material 110. However, example embodiments of blending the TPU and TPE are not limited herein.

Alternatively or additionally, as shown in FIG. 1B, a third material 127 may be positioned between the first material 105 and the second material 110 to achieve full adhesion between the first material 105 and the second material 110. In at least one example embodiment, the third material 127 may be a bond layer configured to bond or adhere the first material 105 to the second material 110. The bond layer may be polyolefin in at least one example embodiment. Additionally, or alternatively, the bond layer may include a material configured to bond to both TPE and TPU. In at least one example embodiment, the bond layer may be a mixture of TPU and TPE. The mixture of TPU and TPE may be obtained as described above with respect to the first material 105 and the second material 110.

In at least one example embodiment, the first material 105 may have a first thickness 115 and the second material 110 may have a second thickness 120. The first thickness 115 may be greater than the second thickness 120. The first thickness 115 and the second thickness 120 may be determined based on the particular use for the tubing 100. An inner diameter 130 may be a diameter of the first material 105 and an outer diameter 135 may be a diameter of the second material 110. In at least one example embodiment, the inner diameter 130 may be about 0.114 inches and the outer diameter 135 may be about 0.187 inches. However, these dimensions are representative of one example embodiment and embodiments are not limited herein.

In at least one example embodiment, TPU may be solvent bondable with particular materials with cyclohexanone. For example, TPU may be bonded to materials such as polyvinyl chloride (PVC), polyethylene terephthalate glycol (PETG), polycyclohexylenedimethylene terephthalate (PCT), methyl methacrylate acrylonitrile butadiene styrene (MABS), acrylonitrile-butadiene-styrene (ABS) copolymer, acrylic, and/or polycarbonate with cyclohexanone and/or a solvent such as methyl ethyl ketone (MEK).

TPU may be more expensive than TPE. Thus, creating tubing with a larger amount of TPE than TPU may reduce costs including manufacturing costs related to tubing. Thus, if it is desirable to include TPU on an exterior of tubing, a majority of the interior of the tubing may be formed from TPE and only a layer on an exterior of the tubing may be formed from TPU.

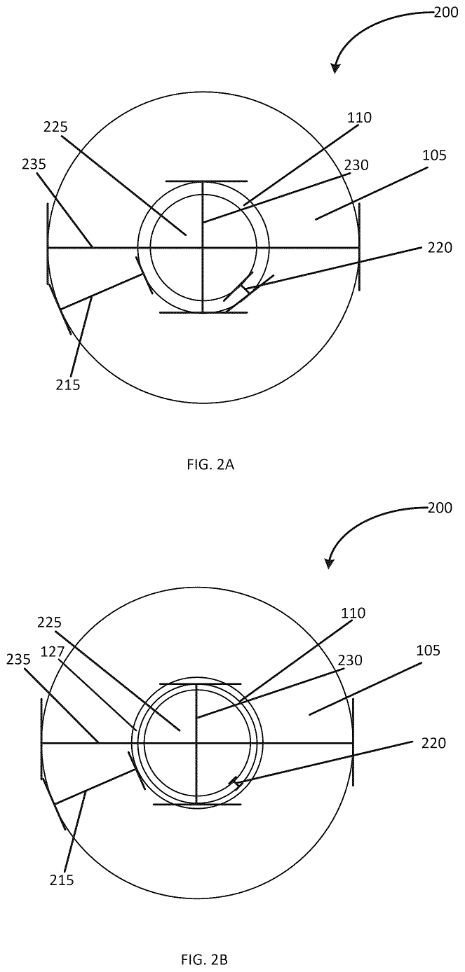

FIGS. 2A and 2B illustrate a cross-section of another example embodiment of tubing 200 in accordance with at least one example embodiment. The tubing 200 may include the first material 105 and the second material 110. As shown in FIG. 2B, the tubing 200 may include the third material 127. The first material 105 may be a first tube and the second material 110 may be a second tube in at least one example embodiment. As shown in FIG. 2A, the first tube may be an outer tube and the second tube may be an inner tube. The outer tube may surround an entirety of an outer circumference of the inner tube to form a circumferentially layered structure.

The first material 105 may be coextruded with the second material 110 and the first material 105 may include a TPE and the second material 110 may include a TPU as described above. Further, as described above, at least one of the first material 105 or the second material 110 may be a blend of TPU and TPE. Additional details of this blend are described above with respect to FIGS. 1A and 1B. As shown in FIG. 2A, the second material 110 may be located proximate to an interior of the tubing such that the second material 110 forms a conduit 225 of the tubing 200. The first material 105 may be coextruded with the second material 110 such that the first material 105 is located on an exterior of the tubing 200.

In at least one example embodiment, it may be desirable to form the conduit 225 from TPU and thus, the second material 110 may be located at an interior portion of the tubing 200. To minimize costs associated with the tubing 200, a majority of the tubing 200 may be formed from the first material 105 as described above with respect to FIGS. 1A and 1B. Thus, the first material 105 may have a first thickness 215 and the second material 110 may have a second thickness 220 where the first thickness 215 is greater than the second thickness 220. Further, when the first material 105 forms an exterior of the tubing 200, the first material 105 may be configured to bond to other TPE materials such as TPE bags, for example.

In at least one example embodiment, an inner diameter 230 may be a diameter of the second material 110 and an outer diameter 235 may be a diameter of the first material 105. In at least one example embodiment, the inner diameter 230 may be about 3.95 mm and the outer diameter 235 may be about 5.95 mm or the inner diameter 230 may be about 4.65 mm and the outer diameter 235 may be about 6.65 mm. However, these dimensions are representative of example embodiments and embodiments are not limited herein.

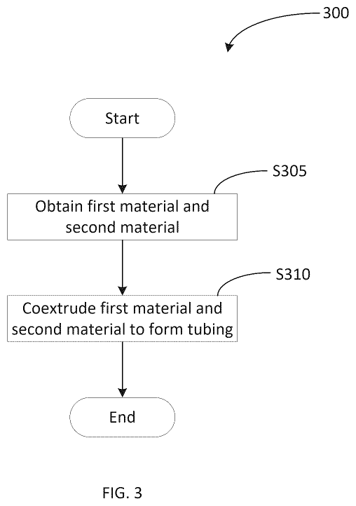

FIG. 3 is a flow chart illustrating a method 300 of manufacturing tubing such as the tubing 100 or the tubing 200 described above. The method 300 may begin at S305 where the first material 105 and the second material 110 are obtained. In at least one example embodiment, a greater amount of the first material 105 may be obtained in order to produce a thicker layer of the first material 105 than the second material 110 as described above. Further, an amount of the first material 105 and the second material 110 may be determined based on specific lengths and thicknesses for a particular use of the tubing.

At S310, the first material 105 may be coextruded with the second material 110. The first material 105 may be coextruded with the second material 110 by conventional methods known in the art. In at least one example embodiment, a bonding layer such as the third material 127 may be used to coextrude the first material 105 with the second material 110. The resulting tubing may be either the tubing 100 or the tubing 200 as described above with respect to FIGS. 1A, 1B, 2A and 2B. The particular tubing may be manufactured based on a use of the tubing. As described above, if the exterior of the tubing is configured to bond with other materials such as PVC, PETG, PCT, MABS, ABS copolymer, acrylic, and/or polycarbonate through the use of cyclohexanone and/or a solvent such as MEK, the second material 110 may be located on an exterior of the tubing. In contrast, if these bonding properties are desired as part of a conduit of the tubing, the second material 110 may be located on an interior of the tubing. By ensuring that the first material 105 is thicker than the second material 110, costs of the tubing may be minimized while retaining desired properties through the use of TPU as the second material 110.

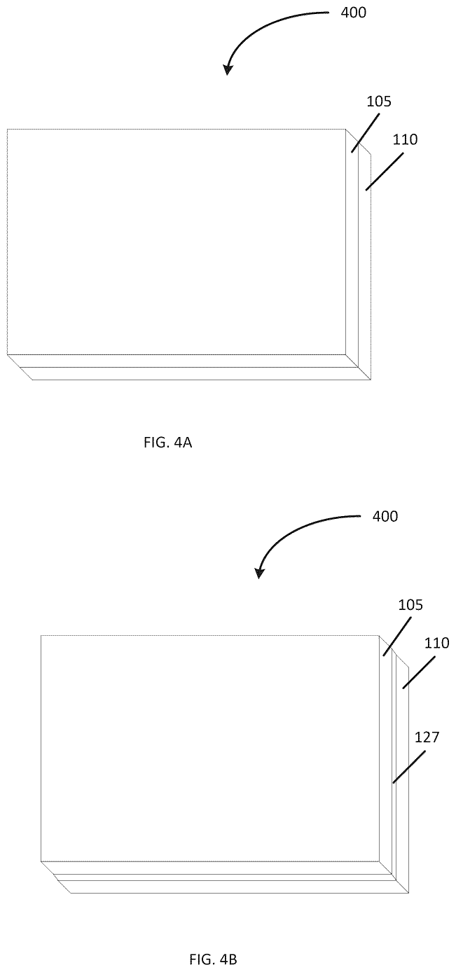

FIGS. 4A and 4B are perspective views of a film 400 according to at least one example embodiment. The film 400 may include the first material 105 and the second material 110 as described above. Bonding between the first material 105 and the second material 110 may be achieved through thermal, chemical, and/or mechanical methods. The thermal, chemical, and/or mechanical bonding methods may be concurrent, consecutive, or successive in at least one example embodiment. The bonding may be determined based on a layer structure of the materials and/or specific product design needs in at least one example embodiment.

As described above, in at least one example embodiment, the first material 105 and/or the second material 110 may be a blend of TPU and TPE. The blend of TPU and TPE for both the first material 105 and the second material 110 may be configured based on a desired cost and application of the tubing 100. In at least one example embodiment, the blend of TPU and TPE may be approximately 50% TPU and 50% TPE. However, example embodiments are not limited herein. In at least one example embodiment, the blend of TPU and TPE may be created by either blending the two polymers during a polymerization process or by first creating two polymers, mixing the two polymers, and then extruding the mixed polymers to create at least one of the first material 105 or the second material 110. However, example embodiments of blending the TPU and TPE are not limited herein.

Alternatively or additionally, as shown in FIG. 4B, the third material 127 may be positioned between the first material 105 and the second material 110 to achieve full adhesion between the first material 105 and the second material 110. In at least one example embodiment, the third material 127 may be a bond layer configured to bond or adhere the first material 105 to the second material 110. The bond layer may be polyolefin in at least one example embodiment. Additionally, or alternatively, the bond layer may include a material configured to bond to both TPE and TPU. In at least one example embodiment, the bond layer may be a mixture of TPU and TPE. The mixture of TPU and TPE may be obtained as described above with respect to the first material 105 and the second material 110.

A thickness of each of the first material 105, the second material 110, and the third material 127 may be determined based on an intended use of the film. However, as described above, if the first material 105 is thicker than the second material 110 or if a greater percentage of the first material 105 is used in a blend of the first material 105 and the second material 110, costs for the film 400 may be reduced.

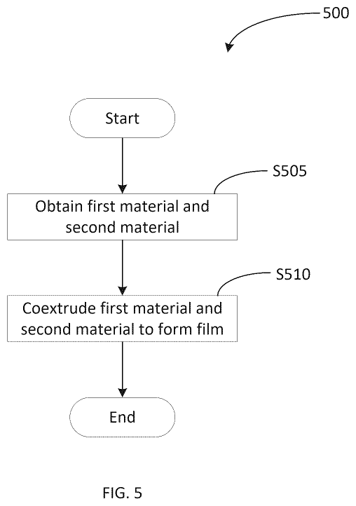

FIG. 5 is a flow chart illustrating a method 500 of manufacturing a film such as the film 400 described above. The method 500 may begin at S505 where the first material 105 and the second material 110 are obtained. In at least one example embodiment, a greater amount of the first material 105 may be obtained in order to produce a thicker layer of the first material 105 than the second material 110 as described above. Further, an amount of the first material 105 and the second material 110 may be determined based on specific lengths and thicknesses for a particular use of the tubing.

At S510, the first material 105 may be coextruded with the second material 110. The first material 105 may be coextruded with the second material 110 by conventional methods known in the art. In at least one example embodiment, a bonding layer such as the third material 127 may be used to coextrude the first material 105 with the second material 110. The resulting film may be the film 400 as described above with respect to FIGS. 4A and 4B. The particular film may be manufactured based on a use of the film. By ensuring that the first material 105 is thicker than the second material 110, costs of the film 400 may be minimized while retaining desired properties through the use of TPU as the second material 110.

In at least one example embodiment, the film 400 may be used for storage of blood, including different blood components. Similarly, the tubing 100 may be used for blood movement within a system such as an apheresis system. However, example uses of the film 400 and the tubing 100 are not limited herein.

The tubing 100 and the film 400 described herein provide various advantages for use in transporting and/or storing blood, particularly in the context of apheresis. In particular, the tubing and films described herein may provide increased bond strength with other materials such as PVC, PETG, PCT, MABS, ABS copolymer, acrylic, and/or polycarbonate as compared to traditional tubing and films used for storing and transporting blood. For example, as illustrated in the chart below, tubing that includes a single layer of blended TPU (“monolayer”) and TPE, tubing that includes an outer blended layer with an inner layer of TPE (“first multi-layer”), and tubing that includes an inner blended layer with an outer layer of TPE (“second multi-layer”) all show increased bond strength as compared to tubing that includes either Styrene Block Copolymer (SBC) or 8300, materials traditionally used in tubing used to transport and/or store blood or blood components when bonded to polycarbonate. In at least one example embodiment, the outer blended layer of the first multi-layer tubing may be a 50/50 blend of TPU and TPE and the inner blended layer of the second multi-layer tubing may include 20% TPU and 80% TPE. Although the data is not included herein, tubing with one or more blended layers of other percentages of TPU and TPE may also provide improved bond strength as compared to materials such as SBC and 8300.

CHART 1
Bond Strength of Tubing Materials

| Material | Bond Strength in Pound Force (LbF) |
|---|---|
| 8300 | 8.20762 |
| SBC | 10.8667 |
| Monolayer | 23.5278 |
| First Multi-Layer | 16.394 |
| Second Multi-Layer | 13.7241 |

Another benefit of the tubing and films described herein is the ability of the tubing and/or film to be radio frequency (RF) sealed. Traditional tubing and/or films used to transport and/or store blood and blood components may not be RF sealed. Further, the tubing and films described herein are biocompatible for blood transportation and storage without a coating of a different material.

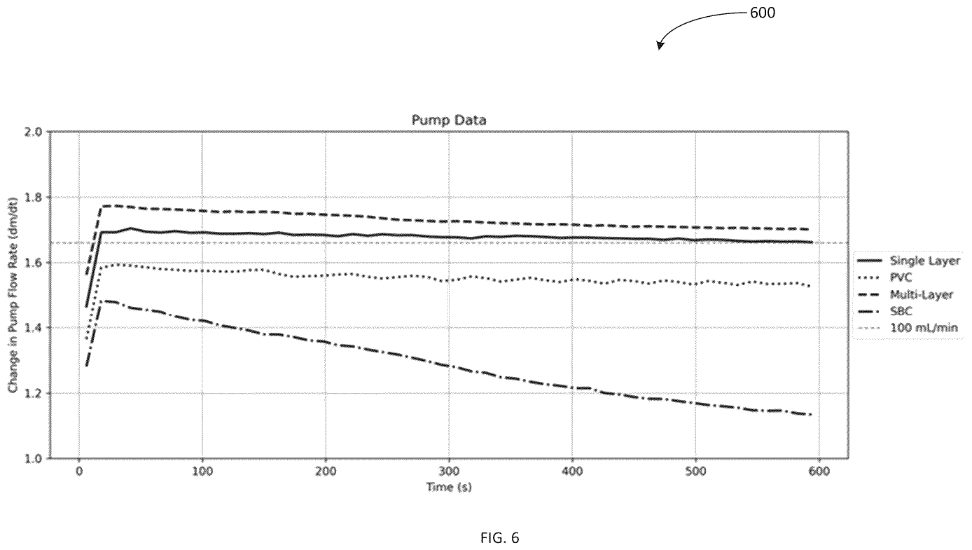

The tubing described herein also enables improved pumping when used in conjunction with one or more fluid pumps. For example, as illustrated in the graph 600 of FIG. 6, a pump flow rate over time is more consistent with the tubing as described herein than with previous tubing configured to store and/or transport blood such as PVC. As illustrated in FIG. 6, a pump flow rate over time was measured for ten minutes for four different materials. The pump was set to operate at a flow rate of 100 mL/minute for each of the four different materials. For each of the materials, when the pump starts at time zero, there is an initial spike on the graph as the pump flow rate changes from the pump being in an off state to being in an on state. It is desirable for tubing to be made from a material that maintains the flow rate of a pump after this initial spike.

As illustrated in FIG. 6, SBC is not a desirable material as it has a large change in flow rate over the ten minute operating time. PVC has the next largest change in flow rate as illustrated in FIG. 6. Thus, neither SBC nor PVC are desirable materials for tubing to be made from when that tubing is used for the medical applications including blood transport and/or storage as described herein. In contrast, the monolayer tubing, noted as “Single Layer” in FIG. 6, resulted in a smallest change in pump flow rate over time as illustrated by the close to horizontal line in FIG. 6. The first multi-layer tubing, noted as “Multi-Layer” in FIG. 6, also performed better than SBC and PVC by having a smaller slope than the lines in the graph 600 for SBC and PVC as illustrated in FIG. 6.

The systems, apparatuses, and methods described herein provide improved tubing. In particular, the systems, apparatuses, and methods described herein may provide improved tubing for use in the medical industry. The tubing may be cost efficient by having a majority formed from TPE while still obtaining benefits of TPU on either an interior or an exterior of the tubing.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

### Non-Limiting Illustrative Embodiments

The following is a list of non-limiting illustrative embodiments disclosed herein:

Illustrative embodiment 1 includes a coextruded tubing comprising: a first material having a first thickness, the first material including thermoplastic elastomer (TPE); and a second material having a second thickness, the second material including a thermoplastic polyurethane (TPU).

Illustrative embodiment 2 includes the coextruded tubing of illustrative embodiment 1, wherein the second material is configured to surround the first material.

Illustrative embodiment 3 includes the coextruded tubing of illustrative embodiment 1, wherein the first material is configured to surround the second material.

Illustrative embodiment 4 includes the coextruded tubing of any of illustrative embodiments 1, 2, and 3, wherein the first thickness is greater than the second thickness.

Illustrative embodiment 5 includes the coextruded tubing of any of illustrative embodiments 1-4, further comprising: a bond material disposed between the first material and the second material.

Illustrative embodiment 6 includes the coextruded tubing of illustrative embodiment 5, wherein the bond material includes polyolefin.

Illustrative embodiment 7 includes the coextruded tubing of any of illustrative embodiments 1-6, wherein the second material includes the TPU blended with the TPE.

Illustrative embodiment 8 includes a method of manufacturing tubing, the method comprising: obtaining a first material and a second material, the first material including a thermoplastic elastomer (TPE) and the second material including a thermoplastic polyurethane (TPU); and coextruding the first material with the second material to form the tubing.

Illustrative embodiment 9 includes the method of illustrative embodiment 8, wherein the second material is configured to surround the first material in the tubing.

Illustrative embodiment 10 includes the method of illustrative embodiment 8, wherein the first material is configured to surround the second material in the tubing.

Illustrative embodiment 11 includes the method of any of illustrative embodiments 8-10, wherein the first material is configured to have a first thickness that is greater than a second thickness of the second material.

Illustrative embodiment 12 includes a coextruded tubing comprising: a first tube having a first thickness, the first tube including thermoplastic elastomer (TPE); and a second tube having a second thickness, the second tube including a thermoplastic polyurethane (TPU).

Illustrative embodiment 13 includes the coextruded tubing of illustrative embodiment 12, wherein the second tube is configured to surround the first tube.

Illustrative embodiment 14 includes the coextruded tubing of illustrative embodiment 12, wherein the first tube is configured to surround the second tube.

Illustrative embodiment 15 includes the coextruded tubing of any of illustrative embodiments 12-14, wherein the first thickness is greater than the second thickness.

Illustrative embodiment 16 includes the coextruded tubing of any of illustrative embodiments 12-15, further comprising: a bond layer disposed between the first tube and the second tube.

Illustrative embodiment 17 includes the coextruded tubing of illustrative embodiment 16, wherein the bond layer includes polyolefin.

Illustrative embodiment 18 includes the coextruded tubing of any of illustrative embodiments 12-17, wherein the second tube includes the TPU blended with the TPE.

Illustrative embodiment 19 includes a coextruded film comprising: a first material having a first thickness, the first material including thermoplastic elastomer (TPE); and a second material having a second thickness, the second material including a thermoplastic polyurethane (TPU).

Illustrative embodiment 20 includes the coextruded film of illustrative embodiment 19, wherein the first thickness is greater than the second thickness.

Illustrative embodiment 21 includes a method of manufacturing a film, the method comprising: obtaining a first material and a second material, the first material including a thermoplastic elastomer (TPE) and the second material including a thermoplastic polyurethane (TPU); and coextruding the first material with the second material to form the film.

Illustrative embodiment 22 includes a coextruded tubing comprising: a first material having a first thickness, the first material including a mix of thermoplastic elastomer (TPE) and thermoplastic polyurethane (TPU); and a second material having a second thickness, the second material including the TPE.

Illustrative embodiment 23 includes the coextruded tubing of illustrative embodiment 22, wherein the second material is configured to surround the first material.

Illustrative embodiment 24 includes the coextruded tubing of illustrative embodiment 22, wherein the first material is configured to surround the second material.

Illustrative embodiment 25 includes the coextruded tubing of any of illustrative embodiments 22-24, wherein the second thickness is greater than the first thickness.

Illustrative embodiment 26 includes a tubing comprising: a first material including a mix of thermoplastic elastomer (TPE) and thermoplastic polyurethane (TPU).

We claim:

1. A coextruded tubing comprising:
a first material having a first thickness, the first material including thermoplastic elastomer (TPE); and
a second material having a second thickness, the second material including a thermoplastic polyurethane (TPU).

2. The coextruded tubing of claim 1, wherein the second material is configured to surround the first material.

3. The coextruded tubing of claim 1, wherein the first material is configured to surround the second material.

4. The coextruded tubing of claim 1, wherein the first thickness is greater than the second thickness.

5. The coextruded tubing of claim 1, further comprising:
a bond material disposed between the first material and the second material.

6. The coextruded tubing of claim 5, wherein the bond material includes polyolefin.

7. The coextruded tubing of claim 1, wherein the second material includes the TPU blended with the TPE.

8. A method of manufacturing tubing, the method comprising:
obtaining a first material and a second material, the first material including a thermoplastic elastomer (TPE) and the second material including a thermoplastic polyurethane (TPU); and
coextruding the first material with the second material to form the tubing.

9. The method of claim 8, wherein the second material is configured to surround the first material in the tubing.

10. The method of claim 8, wherein the first material is configured to surround the second material in the tubing.

11. The method of claim 8, wherein the first material is configured to have a first thickness that is greater than a second thickness of the second material.

12. A coextruded tubing comprising:
a first tube having a first thickness, the first tube including thermoplastic elastomer (TPE); and
a second tube having a second thickness, the second tube including a thermoplastic polyurethane (TPU).

13. The coextruded tubing of claim 12, wherein the second tube is an outer tube configured to surround the first tube.

14. The coextruded tubing of claim 12, wherein the first tube is an outer tube configured to surround the second tube.

15. The coextruded tubing of claim 12, wherein the first thickness is greater than the second thickness.

16. The coextruded tubing of claim 12, further comprising:
a bond layer disposed between the first tube and the second tube.

17. The coextruded tubing of claim 16, wherein the bond layer includes polyolefin.

18. The coextruded tubing of claim 12, wherein the second tube includes the TPU blended with the TPE.
